(19) United States
(12) Patent Application Publication
(10) Pub. No.: US 2020/0303766 A1
(43) Pub. Date: Sep. 24, 2020

(54) METHOD FOR MANUFACTURING SECONDARY BATTERY

(71) Applicant: Murata Manufacturing Co., Ltd., Nagaokakyo-shi (JP)

(72) Inventors: Etsuo Nishikawa, Nagaokakyo-shi (JP); Yuji Kimura, Nagaokakyo-shi (JP); Teppei Akiyoshi, Nagaokakyo-shi (JP)

(21) Appl. No.: 16/893,457

(22) Filed: Jun. 5, 2020

Related U.S. Application Data
(63) Continuation of application No. PCT/JP2018/045459, filed on Dec. 11, 2018.

(30) Foreign Application Priority Data
Dec. 12, 2017 (JP) 2017-237887

(51) Int. Cl. H01M 10/058

(52) U.S. Cl. CPC H01M 10/058

(57) ABSTRACT

A method for manufacturing a secondary battery that includes providing a surfactant layer on an exterior body housing an electrode assembly, and then laser processing the exterior body.

### CROSS REFERENCE TO RELATED APPLICATIONS

The present application is a continuation of International application No. PCT/JP2018/045459, filed Dec. 11, 2018, which claims priority to Japanese Patent Application No. 2017-237887, filed Dec. 12, 2017, the entire contents of each of which are incorporated herein by reference.

### FIELD OF THE INVENTION

The present invention relates to a method for manufacturing a secondary battery. In particular, the present invention relates to a method for manufacturing a secondary battery that includes an electrode assembly including an electrode constituent layer having a positive electrode and a negative electrode, and includes an exterior body.

### BACKGROUND OF THE INVENTION

Secondary batteries can be repeatedly charged and discharged and are also referred to as storage batteries, and are used for various applications. For example, secondary batteries are used in mobile devices such as mobile phones, smartphones, and laptop computers.

A secondary battery includes at least a positive electrode, a negative electrode, and a separator between the positive electrode and the negative electrode. The positive electrode includes a positive electrode material layer and a positive electrode current collector, and the negative electrode includes a negative electrode material layer and a negative electrode current collector. In an electrode assembly used in the secondary battery, a plurality of such positive electrodes and negative electrodes are stacked with a separator interposed therebetween, and the electrode assembly in the form of a stacked body is housed in an exterior body to configure the secondary battery.

Patent Document 1: Japanese Translation of PCT International Application Publication No. 2015-536036

Patent Document 2: Japanese Patent Application Laid-Open No. 2007-175725

Patent Document 3: Japanese Patent Application Laid-Open No. 2001-170791

### SUMMARY OF THE INVENTION

The inventors of the present application have noticed that there is a problem to be overcome in the conventional technique for manufacturing a secondary battery, and have found that it is necessary to take measures for overcoming the problem. The inventors of the present application have specifically found that there is a problem described below.

In the manufacture of a secondary battery, an exterior body is used for housing an electrode assembly, and the exterior body is processed. For example, the exterior body is processed to obtain the desired surface or the desired size. The inventors of the present application have found that although the exterior body is processed as described above to obtain favorable results, some of the results are not necessarily favorable.

It has been specifically found that a scattering object generated due to the laser processing of the exterior body can have an adverse effect on the secondary battery. For example, a scattering object such as dross generated due to the laser processing may adhere to the exterior body, and may impair the appearance of the battery and induce a battery failure if not removed. Although there is room for reducing such scattering objects by adjusting the laser processing condition, it is difficult to completely eliminate the generation itself of the scattering object.

It is conceivable that the scattering object adhering to the exterior body is removed with a brush (Patent Document 2). In the case of a small product, however, it is not possible to remove the scattering object that has entered the gap narrower than the brush bristle, and the product is mechanically rubbed with a brush, so that a fine scratch remains on the part subjected to the removing treatment. The method of removing a scattering object with a brush requires a station for removing the scattering object, so that the equipment is large. It is also conceivable to adhere a film in advance (Patent Document 3), however, the work of adhering the film and the work of removing the film are individually required, so that the work is complicated. There is also a problem that it is difficult to adhere a film to the exterior body having a shape that is not simple.

The present invention has been made in view of such a problem. That is, a main object of the present invention is to provide a technique for manufacturing a secondary battery in which inconveniences due to the laser processing of the exterior body are further reduced.

The inventors of the present application attempted to solve the above-described problem by responding in a new direction, not in the extended direction of the conventional technique. As a result, the invention of a technique for manufacturing a secondary battery has been accomplished in which the main object described above is achieved.

According to the present invention, there is provided a method for manufacturing a secondary battery having an electrode assembly and an exterior body housing the electrode assembly, the method including placing a surfactant layer on at least a part of the exterior body of the secondary battery, and then laser processing the exterior body.

According to the present invention, inconveniences due to the laser processing of the exterior body can be further effectively reduced to easily obtain a desired secondary battery.

Specifically, the surfactant layer according to the present invention is structured to protect the exterior body from a scattering object during the laser processing of the exterior body. In an exemplary aspect, the surfactant layer acts in such a way that it exhibits a water-repellent effect on the scattering object to further suitably protect the area of the exterior body under the surfactant layer from the scattering object.

Compared with in the conventional method, there is no need to use a mechanical means such as a brush, so that the surface of the exterior body is not unnecessarily scratched. In addition, because the surfactant layer can be formed by applying a liquid raw material, there is no need of a bulky station required for the removal with a brush. Furthermore, in the method for manufacturing according to the present invention, the surfactant layer is relatively simply removed by washing away with water or the like after the laser processing.

In particular, in the method for manufacturing according to the present invention, dirt such as oil can be removed from the exterior body by a cleaning effect of the surfactant itself by such washing away, so that a further favorable result can be obtained for the final secondary battery product.

### BRIEF EXPLANATION OF THE DRAWINGS

FIGS. 1(A) and 1(B) are sectional views schematically showing an electrode stacked structure (FIG. 1(A): a non-wound planar stacked structure, FIG. 1(B): a wound structure).

FIGS. 2(A) and 2(B) are schematic sectional views for explaining a feature of the method for manufacturing according to an embodiment of the present invention (FIG. 2(A): laser processing in which a scattering object is repelled and ejected; FIG. 2(B): laser processing in which a scattering object is not repelled and is ejected).

FIG. 3 is a schematic sectional view for explaining an aspect of performing laser cutting as laser processing.

FIG. 4 is a schematic sectional view for exemplarily illustrating an aspect of combination use of an assist gas.

FIG. 5 is a schematic sectional view for explaining laser cutting for cutting off the edge portion of an exterior body.

FIG. 6 is a schematic perspective view for explaining the protruding form of an exterior body.

FIGS. 7(A) and 7(B) are a schematic plan view, sectional view, and perspective view for explaining a problem found by the inventors of the present application in laser processing performed on the exterior body (FIG. 7(A): with a fixing stand set normally, FIG. 7(B): with a fixing stand set below).

FIGS. 8(A) to 8(C) are schematic sectional views for exemplarily illustrating a location where a surfactant layer is formed (FIG. 8(A): the whole portion, FIG. 8(B): the portion excluding a fixing stand position, FIG. 8(C): the side surface in the vicinity).

FIGS. 9(a) to 9(c) are schematic sectional views for explaining an “aspect of dross repelling” (FIG. 9(a): before providing a surfactant layer, FIG. 9(b): after providing a surfactant layer, FIG. 9(c): during laser processing).

FIGS. 10(a) to 10(c) are schematic sectional views for explaining an “aspect of an inverted exterior body” (FIG. 10(a): before providing a surfactant layer, FIG. 10(b): after providing a surfactant layer, FIG. 10(c): during laser processing).

FIGS. 11(a) to 11(c) are schematic sectional views for explaining an “aspect of simple removal” (FIG. 11(a): during laser processing, FIG. 11(b): after laser processing, FIG. 11(c): removal of a surfactant layer).

FIGS. 12(I) and 12(II) are schematic views showing a specific exemplary aspect of an exterior body subjected to laser cutting according to the present invention (FIG. 12(I): a perspective view, FIG. 12(II): a sectional view).

FIGS. 13(A) to 13(C) are schematic sectional views for explaining that the present invention can be applied to various exterior body shapes (FIG. 13(A): a tapered side surface tapering toward the lower side, FIG. 13(B): a tapered side surface tapering toward the upper side, FIG. 13(C): a tapered side surface tapering toward the particular portion within the particular part).

FIG. 14 is a table showing conditions and results in Examples.

### DETAILED DESCRIPTION OF THE INVENTION

Hereinafter, the “method for manufacturing a secondary battery” according to an embodiment of the present invention will be described in more detail. Although the description will be made with reference to the drawings as necessary, various elements in the drawings are shown only schematically and exemplarily for understanding of the present invention, and the appearance and the dimensional ratio can be different from a real one.

The “section view (or sectional view)” described directly or indirectly in the present description is based on a virtual section of an object cut along the stacking direction of the electrode material layers included in the secondary battery (the thickness direction of the battery or the electrode material layer). Furthermore, the “planar view (or plan view)” described directly or indirectly in the present description is based on a form of an object viewed from the outside in the stacking direction of the electrode material layers included in the secondary battery (the thickness direction of the battery, the electrode assembly, or the electrode material layer).

Furthermore, the up-down direction and the left-right direction used directly or indirectly in the present description correspond to the up-down direction and the left-right direction in the drawings, respectively. Unless otherwise specified, the same reference symbol or reference numeral indicates the same member or the same meaning. In a suitable embodiment, it is possible to comprehend that the downward direction in the vertical direction (that is, the direction in which gravity acts) corresponds to the “downward direction”, and the opposite direction corresponds to the “upward direction”.

[Configuration of Secondary Battery Manufactured by the Present Invention]

According to the method for manufacturing according to the present invention, a secondary battery is produced. As used herein, the term “secondary battery” refers to a battery that can be repeatedly charged and discharged. Therefore, the secondary battery produced by the method for manufacturing according to the present invention is not extremely limited by its name, and examples of the secondary battery include power storage devices.

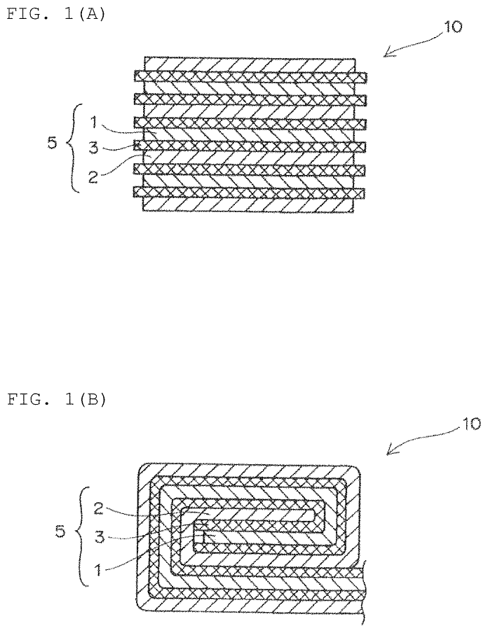

The secondary battery according to the present invention has an electrode assembly in which electrode constituent layers including a positive electrode, a negative electrode, and a separator are stacked. FIGS. 1(A) and 1(B) schematically illustrate an electrode assembly 10. As shown in FIGS. 1(A) and 1(B), a positive electrode 1 and a negative electrode 2 are stacked with a separator 3 interposed therebetween to form an electrode constituent layer 5, and at least one or more such electrode constituent layers 5 are stacked to configure the electrode assembly 10. In the secondary battery, such an electrode assembly is enclosed in an exterior body together with an electrolyte (for example, a nonaqueous electrolyte). Note that the structure of the electrode assembly is not necessarily limited to a planar stacked structure (FIG. 1(A)) and a wound structure (FIG. 1(B)), and may be a so-called stack and folding structure in which the positive electrode, the separator, and the negative electrode are stacked on a long film and then folded.

The positive electrode includes at least a positive electrode material layer and a positive electrode current collector. In the positive electrode, the positive electrode material layer is provided on at least one surface of the positive electrode current collector, and the positive electrode material layer contains a positive electrode active material as an electrode active material. For example, each of the positive electrodes in the electrode assembly may have the positive electrode material layer provided on both the surfaces of the positive electrode current collector, or may have the positive electrode material layer provided only on one surface of the positive electrode current collector.

From the viewpoint of further increasing the capacity of the secondary battery, the positive electrode preferably has the positive electrode material layer provided on both the surfaces of the positive electrode current collector.

The negative electrode includes at least a negative electrode material layer and a negative electrode current collector. In the negative electrode, the negative electrode material layer is provided on at least one surface of the negative electrode current collector, and the negative electrode material layer contains a negative electrode active material as an electrode active material. For example, each of the negative electrodes in the electrode assembly may have the negative electrode material layer provided on both the surfaces of the negative electrode current collector, or may have the negative electrode material layer provided only on one surface of the negative electrode current collector.

From the viewpoint of further increasing the capacity of the secondary battery, the negative electrode preferably has the negative electrode material layer provided on both the surfaces of the negative electrode current collector.

The electrode active material contained in the positive electrode and the negative electrode, that is, the positive electrode active material and the negative electrode active material are materials directly involved in the transfer of electrons in the secondary battery, and are the main materials of the positive and negative electrodes responsible for the charge and discharge, that is, the battery reaction. More specifically, ions are brought to the electrolyte due to the “positive electrode active material contained in the positive electrode material layer” and the “negative electrode active material contained in the negative electrode material layer”, and the ions move between the positive electrode and the negative electrode to transfer the electrons for the charge and discharge. The positive electrode material layer and the negative electrode material layer are particularly preferably capable of absorbing and releasing a lithium ion. That is, a nonaqueous electrolyte secondary battery is preferable in which lithium ions move between the positive electrode and the negative electrode via the nonaqueous electrolyte to charge and discharge the battery. When lithium ions are involved in the charge and discharge, the secondary battery produced by the method for manufacturing according to the present invention corresponds to a so-called lithium ion battery, and the positive electrode and the negative electrode have a layer capable of absorbing and releasing a lithium ion.

When the positive electrode active material of the positive electrode material layer includes, for example, a granular material, the positive electrode material layer preferably contains a binder for further sufficient contact between the grains and for keeping the shape. In addition, the positive electrode material layer may contain a conductive auxiliary in order to facilitate the transfer of the electrons for promoting the battery reaction. Similarly, when the negative electrode active material of the negative electrode material layer includes, for example, a granular material, the negative electrode material layer preferably contains a binder for further sufficient contact between the grains and for keeping the shape, and may contain a conductive auxiliary in order to facilitate the transfer of the electrons for promoting the battery reaction. As described above, the positive electrode material layer and the negative electrode material layer have a form in which a plurality of components are contained, so that they can also be referred to as a positive electrode mixture layer and a negative electrode mixture layer, respectively.

The positive electrode active material preferably contributes to the absorbing and releasing of a lithium ion. From this viewpoint, the positive electrode active material is preferably, for example, a lithium-containing complex oxide. More specifically, the positive electrode active material is preferably a lithium transition metal complex oxide containing lithium and at least one transition metal selected from the group consisting of cobalt, nickel, manganese, and iron. That is, the positive electrode material layer of the secondary battery produced by the method for manufacturing according to the present invention preferably contains such a lithium transition metal complex oxide as a positive electrode active material. For example, the positive electrode active material may be lithium cobaltate, lithium nickelate, lithium manganate, lithium iron phosphate, or a material in which a part of the above-mentioned transition metal is replaced with another metal. Such a positive electrode active material may be contained as a single species, and two or more positive electrode active materials may be contained in combination.

As only an example, in the secondary battery produced by the method for manufacturing according to the present invention, the positive electrode active material contained in the positive electrode material layer may be lithium cobaltate.

The binder that can be contained in the positive electrode material layer is not particularly limited, and examples of the binder include at least one selected from the group consisting of polyvinylidene fluoride, a vinylidene fluoride-hexafluoropropylene copolymer, a vinylidene fluoride-tetrafluoroethylene copolymer, polytetrafluoroethylene, and the like. The conductive auxiliary that can be contained in the positive electrode material layer is not particularly limited, and examples of the conductive auxiliary include at least one selected from carbon blacks such as thermal black, furnace black, channel black, Ketjen black, and acetylene black, carbon fibers such as graphite, carbon nanotubes, and vapor phase growth carbon fibers, metal powders such as copper, nickel, aluminum, and silver, polyphenylene derivatives, and the like. For example, the binder of the positive electrode material layer may be polyvinylidene fluoride, and the conductive auxiliary of the positive electrode material layer may be a carbon black. As only an example, the binder and the conductive auxiliary of the positive electrode material layer may be polyvinylidene fluoride and a carbon black in combination.

The negative electrode active material preferably contributes to the absorbing and releasing of a lithium ion. From this viewpoint, the negative electrode active material is preferably, for example, various carbon materials, oxides, lithium alloys, or the like.

Examples of the various carbon materials of the negative electrode active material include graphite (natural graphite, artificial graphite), hard carbon, soft carbon, and diamond-like carbon. In particular, graphite is preferable because of its high electron conductivity, excellent adhesiveness to the negative electrode current collector, and the like. Examples of the oxide of the negative electrode active material include at least one selected from the group consisting of silicon oxide, tin oxide, indium oxide, zinc oxide, lithium oxide, and the like. The lithium alloy of the negative electrode active material is required to be an alloy with any metal that can form an alloy with lithium, and may be, for example, a binary, ternary or higher alloy of lithium with metals such as Al, Si, Pb, Sn, In, Bi, Ag, Ba, Ca, Hg, Pd, Pt, Te, Zn, and La.

Such an oxide preferably has an amorphous structural form. This is because deterioration due to nonuniformity such as a crystal grain boundary or a defect is hardly caused. As only an example, in the secondary battery produced by the method for manufacturing according to the present invention, the negative electrode active material of the negative electrode material layer may be artificial graphite.

The binder that can be contained in the negative electrode material layer is not particularly limited, and examples of the binder include at least one selected from the group consisting of styrene-butadiene rubber, polyacrylic acid, polyvinylidene fluoride, a polyimide-based resin, and a polyamideimide-based resin. For example, the binder contained in the negative electrode material layer may be styrene butadiene rubber. The conductive auxiliary that can be contained in the negative electrode material layer is not particularly limited, and examples of the conductive auxiliary include at least one selected from carbon blacks such as thermal black, furnace black, channel black, Ketjen black, and acetylene black, carbon fibers such as graphite, carbon nanotubes, and vapor phase growth carbon fibers, metal powders such as copper, nickel, aluminum, and silver, polyphenylene derivatives, and the like. The negative electrode material layer may contain a component derived from the thickener component (for example, carboxymethyl cellulose) used during manufacturing the battery.

As only an example, the negative electrode active material and the binder in the negative electrode material layer may be artificial graphite and styrene-butadiene rubber in combination.

The positive electrode current collector and the negative electrode current collector used in the positive electrode and the negative electrode are members that contribute to collecting and supplying the electrons generated in the active material due to the battery reaction. Such a current collector may be a sheet-shaped metal member, and may have a porous or perforated form. For example, the current collector may be a metal foil, a punched metal, a net, an expanded metal, or the like. The positive electrode current collector used in the positive electrode preferably include a metal foil containing at least one selected from the group consisting of aluminum, stainless steel, nickel, and the like, and may be, for example, an aluminum foil. The negative electrode current collector used in the negative electrode preferably include a metal foil containing at least one selected from the group consisting of copper, stainless steel, nickel, and the like, and may be, for example, a copper foil.

The separator used in the positive electrode and the negative electrode is a member provided from the viewpoint of preventing a short circuit due to the contact between the positive electrode and the negative electrode, keeping the electrolyte, and the like. In other words, it can be said that the separator is a member that passes ions while preventing the electronic contact between the positive electrode and the negative electrode. Preferably, the separator is a porous or microporous insulating member and has a film form due to its small thickness. As only an example, a microporous polyolefin film may be used as the separator. In this regard, the microporous film used as the separator may contain, for example, only polyethylene (PE) or only polypropylene (PP) as the polyolefin. Furthermore, the separator may be a stacked body including “a microporous PE film” and “a microporous PP film”. The surface of the separator may be covered with an inorganic grain coat layer, an adhesive layer, or the like.

The surface of the separator may have adhesiveness. In the present invention, the separator should not be particularly limited by its name, and may be a solid electrolyte, a gel electrolyte, an insulating inorganic grain, or the like having the same function.

In the secondary battery produced according to the present invention, the electrode assembly including the electrode constituent layer including the positive electrode, the negative electrode, and the separator is enclosed in an exterior together with the electrolyte. When the positive electrode and the negative electrode have a layer capable of absorbing and releasing a lithium ion, the electrolyte is preferably a “non-water-based” electrolyte such as an organic electrolyte or an organic solvent (that is, the electrolyte is preferably a nonaqueous electrolyte). The metal ions released from the electrodes (the positive electrode and the negative electrode) exist in the electrolyte, and therefore the electrolyte assists the move of the metal ions in the battery reaction.

The nonaqueous electrolyte is an electrolyte containing a solvent and a solute. The specific solvent in the nonaqueous electrolyte preferably contains at least a carbonate. Such a carbonate may be a cyclic carbonate and/or a chain carbonate. Examples of the cyclic carbonate are not particularly limited, and include at least one selected from the group consisting of propylene carbonate (PC), ethylene carbonate (EC), butylene carbonate (BC), and vinylene carbonate (VC). Examples of the chain carbonate include at least one selected from the group consisting of dimethyl carbonate (DMC), diethyl carbonate (DEC), ethyl methyl carbonate (EMC), and dipropyl carbonate (DPC). As only an example, a cyclic carbonate and a chain carbonate may be used in the nonaqueous electrolyte in combination, and for example, a mixture of ethylene carbonate and diethyl carbonate may be used. As a specific solute in the nonaqueous electrolyte, for example, an Li salt such as LiPF₆ and/or LiBF₄ is preferably used.

The exterior body of the secondary battery enfolds the electrode assembly in which the electrode constituent layers including the positive electrode, the negative electrode, and the separator are stacked, and may be in the form of a hard case or a soft case. Specifically, the exterior body may be a hard case corresponding to a so-called metal can, or may be a soft case corresponding to a pouch of a so-called laminate film.

[Feature of Method for Manufacturing According to the Present Invention]

The method for manufacturing according to the present invention has a feature in the process performed on the exterior body of the secondary battery. In particular, the method has a feature related to the process performed prior to the laser processing of the exterior body.

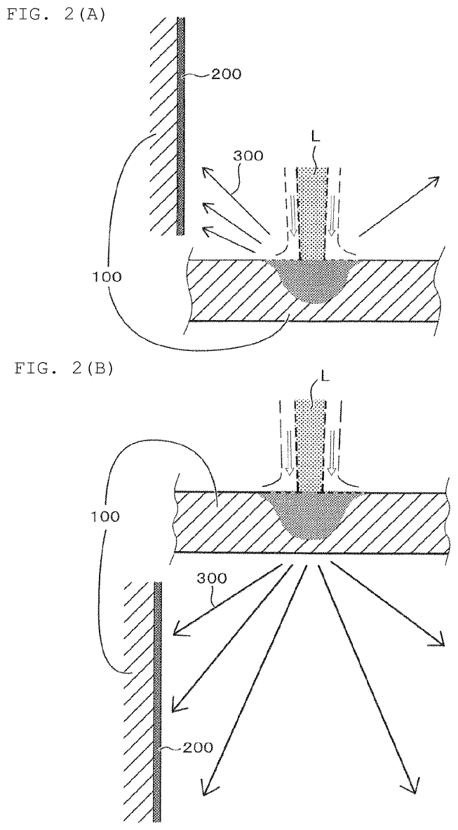

The secondary battery has the electrode assembly and the exterior body housing the electrode assembly. In the method for manufacturing according to the present invention, a surfactant layer is provided on the exterior body prior to the laser processing of the exterior body. That is, as shown in FIGS. 2(A) and 2(B), the laser processing is performed by irradiating an exterior body 100 with a laser L in a state where a surfactant layer 200 is provided on the exterior body 100.

During the laser processing, a desired effect is brought to the exterior body by the heat due to the irradiation with the laser, but such processing causes a scattering object. For example, in the irradiated part and the vicinity thereof of the exterior body, a phenomenon can occur in which a substance derived from the exterior body material scatters to the surroundings under the influence of the laser heat. Such a scattering object can be adhered to the exterior body and affect the appearance of the manufactured battery. That is, since the exterior body houses the electrode assembly and forms the appearance of the secondary battery, the scattering object adhered to the surface of the exterior body impairs the final appearance of the secondary battery product. In addition, the scattering object generated by the laser processing can affect the performance of the manufactured battery. The scattering object usually contains a metal component of the exterior body, and the metal component unintentionally adhered to the exterior body causes a battery failure.

In the method for manufacturing according to the present invention, the surfactant layer is provided in advance on the exterior body in order to reduce such influence of the scattering object during the laser processing. In particular, the surfactant layer is placed at least in the area of the exterior body excluding the area subjected to the laser processing. Even when an undesired scattering object 300 is generated during the laser processing, the surfactant layer 200 provided on the exterior body 100 can act so that the scattering object 300 does not adhere to the exterior body 100 (see FIGS. 2(A) and 2(B)). The action resides at least in that the surfactant layer is located between the exterior body surface and the laser irradiation portion. This is because the surfactant layer located between the exterior body surface and the laser irradiation portion prevents the scattering object from adhering to the exterior body. As described above, in the method for manufacturing according to the present invention, the exterior body is suitably protected from the scattering object during the laser processing by the surfactant layer provided on the exterior body.

As can be seen from the above, the surfactant layer in the present invention is used during the laser processing, and can be referred to as a “surfactant layer for laser processing”, a “protective surfactant layer against a flying object in laser processing”, or the like.

In the present description, the phrase “area of the exterior body excluding an area subjected to the laser processing” refers to an area of the exterior body excluding the part irradiated with the laser during the laser processing. Therefore, the phrase “the surfactant layer is provided at least in an area of the exterior body excluding an area subjected to the laser processing” in the present invention means that the surfactant layer is provided in the area excluding the area subjected to the laser processing as a matter of course, and may be additionally provided in the area subjected to the laser processing. In this case, the surfactant layer may be provided on at least a part of the area of the exterior body excluding the area subjected to the laser processing, and may be provided over a wider area to the whole extent (particularly in consideration of ease of the providing, the surfactant layer may be equally provided over an area or the whole area of the exterior body surface excluding the area subjected to the laser processing).

The present invention is based on the premise that the laser processing is performed in the method for manufacturing a secondary battery. In a broad sense, the term “laser processing” as used herein means to process an object using a laser, and in a narrow sense, to process the exterior body of the secondary battery at least by a thermal effect due to laser absorption. Such laser processing is particularly preferably performed on the exterior body of the secondary battery before the housing of the electrode assembly. Examples of the laser processing is not particularly limited, and include laser removal processing such as laser ablation, laser drilling, and laser cutting, and laser welding.

In a broad sense, the term “scattering object” as used herein means a derivative that can be generated from an object during the laser processing, and in a narrow sense, a substance that scatters from the laser irradiation portion of the exterior body of the secondary battery to the surroundings during the laser processing, and particularly the substance containing at least a component of the exterior body (more specifically, a metal component of the exterior body). When the base point is the “area of the exterior body excluding the area subjected to the laser processing”, the scattering object corresponds to an object flying toward that area during the laser processing, and thus can be also referred to as a “laser flying object”.

In a suitable aspect, the surfactant layer acts in such a way that it exhibits a water-repellent effect on the scattering object to protect the area of the exterior body under the surfactant layer from the scattering object. More specifically, the scattering object ejected from the laser irradiation portion of the exterior body of the secondary battery is, rather than absorbed by the surfactant layer, present on the surface without being absorbed by the surfactant layer, or moves smoothly on the surface of the surfactant layer. That is, the surfactant layer of a suitable aspect does not have a high affinity for the scattering object, and therefore, the scattering object reaching the surfactant layer interacts with an external force effect (for example, a gravitational effect and/or a surrounding gas flow effect) and the like to preferably move smoothly and/or be repelled. Due to the effect of the surfactant layer, the scattering object during the laser processing does not eventually adhere to the exterior body surface, and the exterior body is suitably protected from the scattering object.

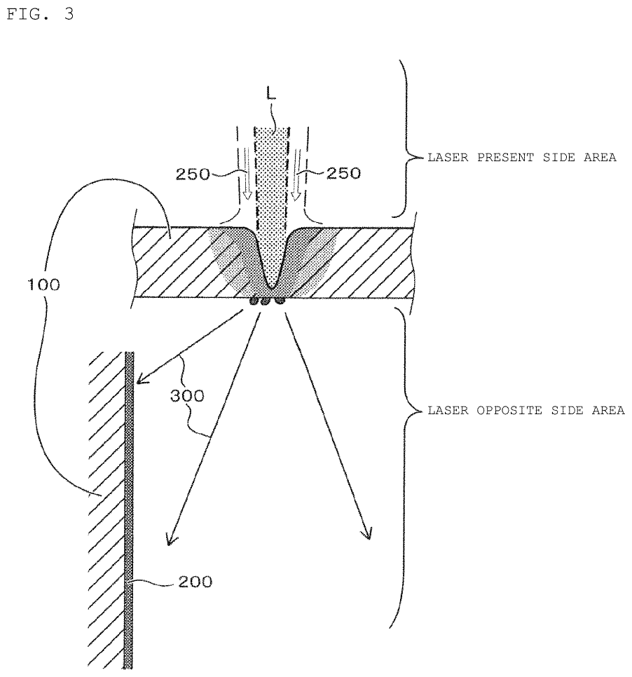

In the method for manufacturing according to the present invention according to a suitable aspect, the laser processing corresponds to laser cutting. That is, the exterior body 100 is irradiated with the laser L and is cut (see FIG. 3). In the present invention, the surfactant layer 200 is provided on the exterior body 100 prior to the laser cutting. During the laser cutting, dross can be particularly generated as the scattering object 300, however, the exterior body 100 is protected from such dross due to the presence of the surfactant layer 200. In a more specific exemplary aspect, even when a molten substance derived from the exterior body is generated with the laser cutting, the surfactant layer acts so that such a molten substance does not adhere to the exterior body surface.

In a broad sense, the term “laser cutting” as used herein means to cut an object using a laser, and in a narrow sense, to cut an object at least by a thermal effect due to laser absorption. The laser cutting is not particularly limited, and may be, for example, either melt cutting or evaporative cutting. The melt cutting is mainly due to oxidation reaction cutting or non-reactive non-oxidation reaction cutting, while the evaporative cutting is mainly due to thermal decomposition and/or thermal degradation.

In the laser cutting, an assist gas is preferably used. In other words, it is preferable to use an assist gas 250 in combination with the laser cutting to more efficiently cut the exterior body 100 (see FIG. 3). In particular, it is preferable to perform the laser cutting with the assist gas sprayed toward the laser irradiation portion. In such laser cutting, the thermal effect of the laser interacts with the external force effect of the assist gas being a jet gas to act to further forcibly separate the cut portion material of the exterior body, so that the cutting is further efficient.

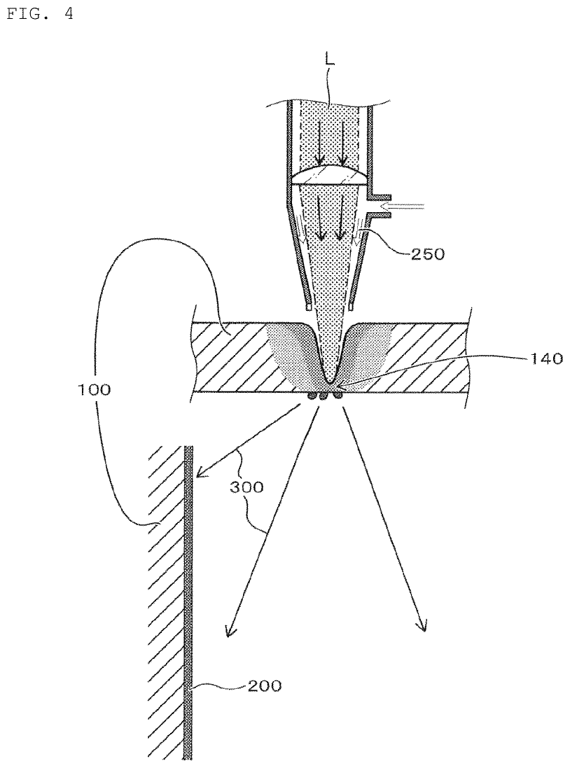

It is preferable that the assist gas 250 flow so that the assist gas 250 and a laser beam L are substantially coaxial (see FIG. 3). As an aspect during the laser cutting, for example, an aspect is preferable in which the assist gas flows toward a laser irradiation portion 140 around the laser beam L as shown in FIG. 4. Such combined use of the assist gas facilitates to forcibly separate the exterior body material melted by the thermal effect of the laser beam from the laser irradiation portion to the outside without adversely affecting the thermal effect of the laser beam.

The assist gas is not particularly limited as long as it contributes to the laser cutting of the exterior body. For example, air, an inert gas (argon and/or nitrogen), or an oxygen gas may be used as the assist gas. As only a specific example, the oxygen gas may be used as the assist gas in the melt cutting mainly due to the oxidation reaction cutting, and the inert gas containing argon and/or nitrogen may be used in the melt cutting mainly due to the non-reaction non-oxidation reaction cutting. In the evaporative cutting, the inert gas may be used, and further, air or the like may be used.

In a suitable aspect, the surfactant layer is provided on the exterior body surface located on the opposite side of the exterior body from the side subjected to the laser processing. In an aspect in which the exterior body is irradiated with the laser from the upper side (see FIG. 3), the surfactant layer is provided on the lower exterior body surface located on the opposite side from the side where the laser exists with the irradiation point of the exterior body as a boundary (hereinafter, such a location is also referred to as a “laser opposite side area”). The surfactant layer provided in such a way can further effectively reduce the influence of the scattering object during the laser processing. This is particularly true when the assist gas is used in combination with the laser cutting. This is because the scattering object has a high tendency to scatter along the flow of the assist gas to the “laser opposite side area”.

In the case of the laser cutting, the “scattering object” in the present invention has a concept including at least dross. That is, when the exterior body is cut by irradiating the exterior body with the laser, examples of the adhering substance derived from the cutting position include dross. In an aspect in which the assist gas is used in combination with the laser cutting, dross flies particularly toward the exterior body surface in the “laser opposite side area” corresponding to the downstream side in the flow direction of the assist gas, so that it is preferable to provide the surfactant layer on such a position.

The term “dross” as used herein refers to the scattering object containing at least a substance at the laser cutting position. That is, the term “dross” refers a substance due to the laser cutting containing at least a substance derived from the exterior body material such as a component included in the material of the exterior body and/or an oxide of the component.

In the method for manufacturing according to the present invention, the surfactant layer can be provided on the exterior body by various methods. In particular, it is preferable to use a raw material layer containing a surfactant and a solvent to form the surfactant layer.

The surfactant is a substance having a property that changes the property of the interface, and particularly a substance having a property that changes the interfacial tension (more specifically, a substance having a property that changes the liquid surface tension). A surfactant is generally a substance having both a hydrophilic portion (for example, a hydrophilic group) and a hydrophobic portion (for example, a hydrophobic group). The surfactant that can be used in the present invention is not particularly limited, and may be an anionic surfactant, a cationic surfactant, a nonionic surfactant, an amphoteric surfactant, or the like. That is, the hydrophilic portion may be anionic, cationic, nonionic or amphoteric (a system having both a cation and an anion). Furthermore, the hydrophilic portion may be a hybrid such as “a system having both an anion and a nonion”, “a system having both a cation and a nonion”, or the like.

From the viewpoint of the molecular structure, the surfactant may include, for example, a saturated hydrocarbon system, an unsaturated hydrocarbon having a benzene ring and/or a naphthalene ring structure, and/or a fluorine system.

As described below, the surfactant used in the method for manufacturing according to the present invention is preferably water-soluble. There are generally two types of surfactants, “water-soluble surfactants” and “oil-based surfactants”, and among them, a water-soluble surfactant is preferably used in the present invention. This means that among the surfactants that reduce the liquid surface tension, a surfactant having an ability to reduce the surface tension of water is particularly preferably used. As only an example, it is preferable to use an alkylsulfate ester-based active agent and/or a sodium salt-form active agent as the surfactant in the present invention, and for example, sodium lauryl sulfate may be used.

The solvent used together with the surfactant is not particularly limited as long as it contributes to the formation of the surfactant layer, and examples of the solvent include water and/or organic solvents. The water may be, for example, purified water such as distilled water, pure water, ultrapure water, or deionized water, or tap water. As the organic solvents, for example, an alcohol such as methanol, ethanol, propanol, isopropyl alcohol (IPA), butanol, or isobutyl alcohol; a ketone such as methyl ethyl ketone or methyl isobutyl ketone (MIBK); a terpene such as α-terpineol, β-terpineol, or γ-terpineol; an ethylene glycol monoalkyl ether; an ethylene glycol dialkyl ether; a diethylene glycol monoalkyl ether; a diethylene glycol dialkyl ether; an ethylene glycol monoalkyl ether acetate; an ethylene glycol dialkyl ether acetate; a diethylene glycol monoalkyl ether acetate; a diethylene glycol dialkyl ether acetate; a propylene glycol monoalkyl ether; a propylene glycol dialkyl ether; or a propylene glycol monoalkyl ether acetate can be used alone, and a mixture of at least one or two or more solvents selected from the above-mentioned solvents can also be used. As only an example, pure water may be used as the solvent. Furthermore, a mixture of water (for example, pure water) and an alcohol (for example, an alcohol such as isopropyl alcohol) may be used as the solvent. The use of not only water but also an alcohol as the solvent is preferable in terms of a drying property after the application, and is also preferable in terms of preventing the raw material layer from foaming. In other words, in the present invention, it can be said that the alcohol such as isopropyl alcohol has an effect of adjusting the drying property and an effect of preventing foaming.

Although not particularly limited, when the surfactant layer is provided for the laser cutting of the exterior body, the raw material layer preferably has an increased surfactant concentration. This is because when the raw material layer has an increased surfactant concentration, the effect of protecting the exterior body during the laser cutting is increased.

That is, when the surfactant layer is formed with the increased surfactant concentration, the scattering object reaching the surfactant layer during the laser cutting interacts with an external force effect (for example, a gravitational effect and/or a surrounding gas flow effect) and the like to further suitably move smoothly and/or be repelled, so that the exterior body is easily protected from the scattering object suitably. As only an example, the raw material layer may have a surfactant concentration of about 1% to 60% by weight, preferably about 2% to 55% by weight, more preferably about 3% to 52% by weight, and more preferably about 4% to 50% by weight based on the total amount of the raw material. As a more specific example, when it is assumed that a mixture of water and an alcohol is a solvent for the raw material layer, the raw material layer may have a surfactant concentration of 1% to 55% by weight, for example, 3% to 54% by weight, 4% to 50% by weight, 4% to 20% by weight, 5% to 15% by weight, or the like (based on the total amount of the raw material layer).

The surfactant layer itself can be formed through an application operation. Specifically, the surfactant layer may be formed by applying the “raw material layer containing a surfactant and a solvent” to the exterior body surface. In such a case, the surfactant layer can contain the surfactant and the solvent, but at least a part of the solvent may be evaporated and removed. A drying treatment may be performed after the application to the exterior body in order to promote the evaporation and removal of the solvent. The drying treatment may be carried out by putting the surfactant layer under reduced pressure or a vacuum, or may be carried out by subjecting the surfactant layer to a heat treatment under atmospheric pressure. If necessary, the putting “under reduced pressure or a vacuum” and the “heat treatment” may be combined.

For applying the raw material layer, a conventional coater means, a brush, a blade, or the like may be used, or the application may be performed in an aspect of a spray. In the present invention, the raw material layer can be provided at an arbitrary position by the application.

In particular, the surfactant layer can be formed at an arbitrary position by “partial application”. Because of such partial application, the application operation can be minimized, and the amount of the used surfactant can be minimized.

The thickness of the surfactant layer formed on the exterior body surface may be, for example, about 0.1 μm to 200 μm, and preferably about 1 μm to 100 μm in a plane portion. The thickness may be equal to or greater than the above-mentioned thickness in a gap between recesses and projections and the like. Here, the term “thickness of the surfactant layer” means the thickness of the surfactant layer during the laser processing. Therefore, when the solvent is removed after the application of the raw material layer, the term means the thickness of the surfactant layer after the removal. Although not particularly limited, the thickness of the surfactant layer provided for the laser cutting of the exterior body is preferably increased.

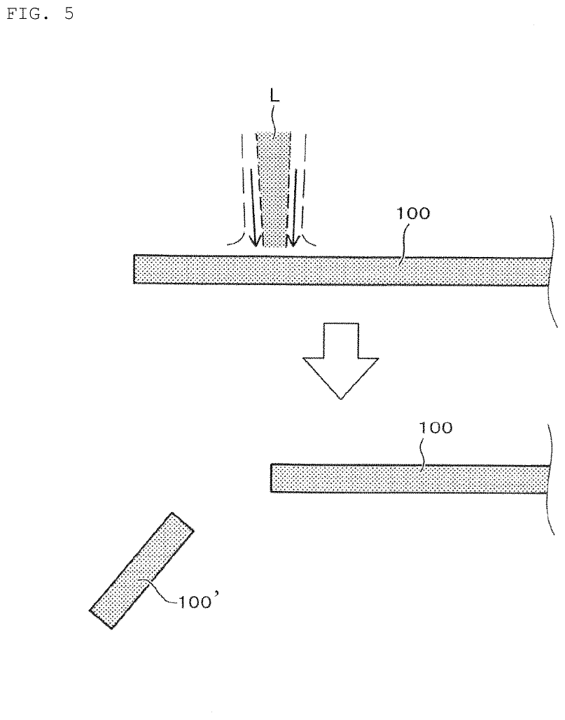

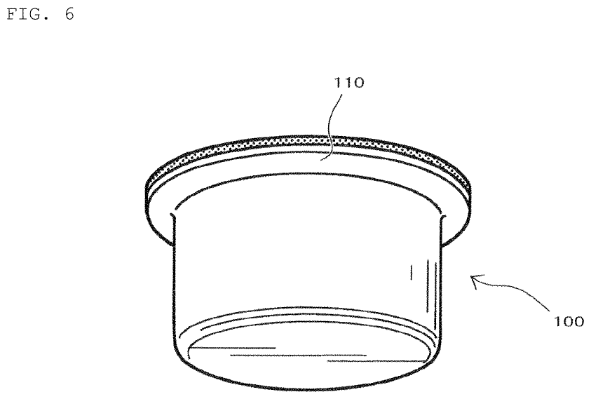

In the method for manufacturing according to the present invention, the laser cutting performed as the laser processing is for, for example, cutting off an edge portion 100′ of the exterior body 100 (see FIG. 5). Here, the inventor of the present application has found that dross is particularly easily adhered to the exterior body surface in the laser cutting for cutting off the edge. That is, in the laser cutting for cutting off such an edge, the effect of the surfactant layer provided in the present invention can be particularly effectively exerted. Detailed description will be made about the effect. The exterior body 100 for enfolding the electrode assembly sometimes initially have an outwardly protruding form as shown in FIG. 6, and the laser cutting for cutting off the edge is performed in order to reduce a protrusion portion 110.

This is particularly true when the exterior body corresponds to a hard case corresponding to a metal can.

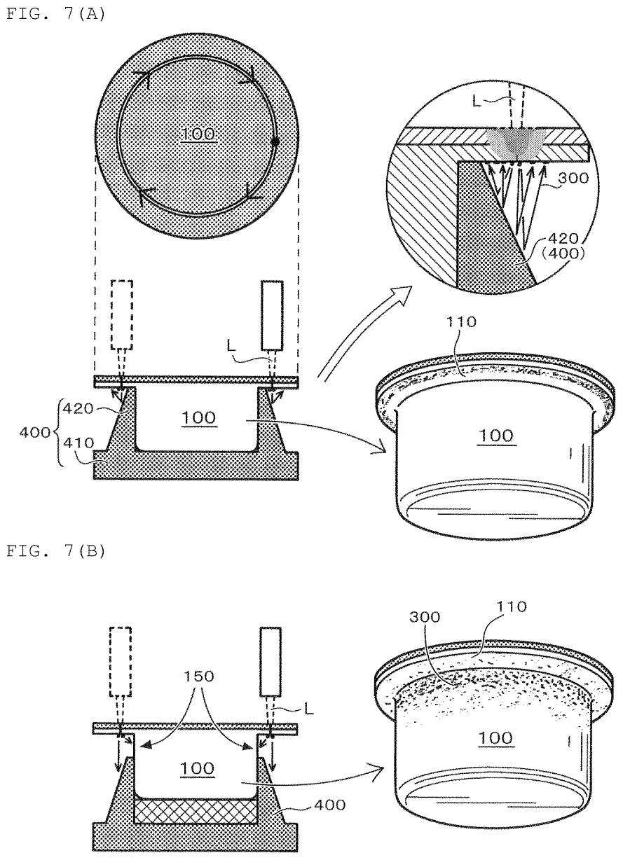

In the laser cutting to reduce the protruding portion (for example, a “collar” portion) of the exterior body 100, a fixing stand 400 as shown in FIG. 7(A) is sometimes used. In other words, the fixing stand 400 is used having a hollow inside for holding the exterior body 100 from the viewpoint of supporting the exterior body during the laser cutting. As shown in the figure, the fixing stand 400 includes at least a base 410 and a side wall 420. When the laser cutting is performed in a state where the fixing stand 400 is used, dross 300 rebounds due to the presence of the fixing stand 400 and easily adheres to the exterior body. As shown in the figure, the dross further rebounds from the side wall 420 of the fixing stand 400, and particularly adheres to the vicinity of the edge-cut exterior body surface. Meanwhile, when the fixing stand 400 is lowered relative to the exterior body 100 as shown in FIG. 7(B) in order to reduce such a rebound, the side surface 150 of the exterior body 100 is partially exposed, and the dross adheres to the exposed surface.

The present invention is based at least on the fact that the inventor has found such a problem, and therefore, in the method for manufacturing according to the present invention, the surfactant layer is preferably provided on the side portion of the exterior body. More specifically, the surfactant layer is preferably provided on the outer surface of the side portion of the exterior body prior to performing the laser cutting for cutting off the edge of the exterior body (especially the laser processing for cutting off the edge to reduce the protruding portion of the exterior body). As a result, such a side portion is separated from the dross during the cutting of the edge, and eventually, the adhering of the dross to the side portion of the exterior body is suitably easily prevented. The surfactant layer provided on the side portion of the exterior body is assumed to be subjected to the laser cutting in an aspect as shown in FIG. 7(B), and of course, the surfactant layer may be provided also on the other exterior body surface portions (for example, the lower surface portion of the protrusion portion 110 of the exterior body).

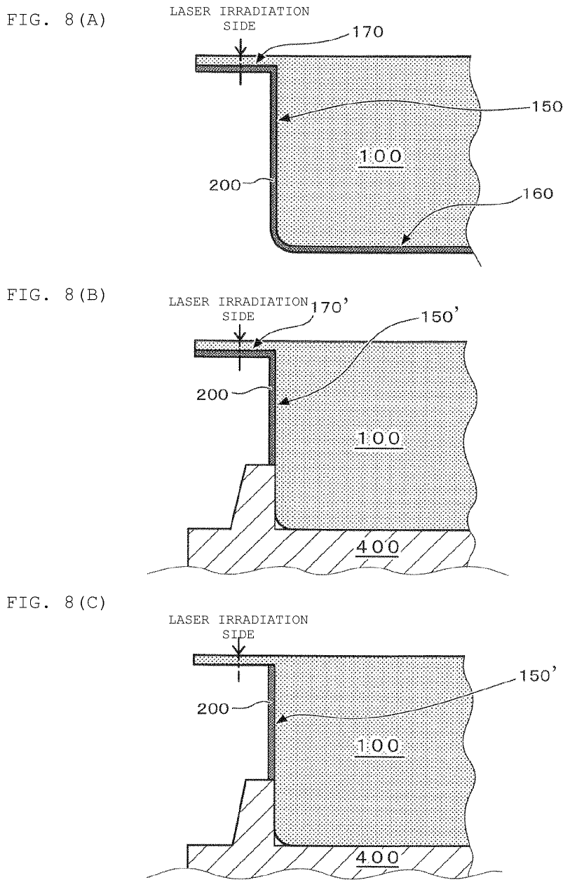

In the method for manufacturing according to the present invention, the surfactant layer is required to be formed at the position on the exterior body surface where any possibility of the dross scattering is considered. Therefore, as shown in FIG. 8(A), the surfactant layer 200 may be provided to the whole extent on the exterior body surface located on the opposite side from the laser irradiation side. In an aspect shown in FIG. 8(A), the surfactant layer 200 is provided not only on the side surface 150 of the exterior body 100, but also on a bottom surface 160 of the exterior body 100 and a lower surface 170 of the protruding portion. When the laser processing is performed using the fixing stand 400, as shown in FIGS. 8(B) and 8(C), the surfactant layer 200 is preferably provided on the part exposed from the fixing stand 400 within the exterior body surface located on the opposite side from the laser irradiation side (in an aspect of FIG. 8(B), the surfactant layer 200 is provided on the exposed side surface portion 150′ and the exposed protruding lower surface portion 170′, and in an aspect of FIG. 8(C), the surfactant layer 200 is provided only on the exposed side surface portion 150′).

The present invention can be embodied in various aspects. Hereinafter, aspects will be described in detail.

(Aspect of Dross Repelling)

This is an aspect in which the exterior body is protected in such a form where the dross during the laser cutting is repelled by the surfactant layer.

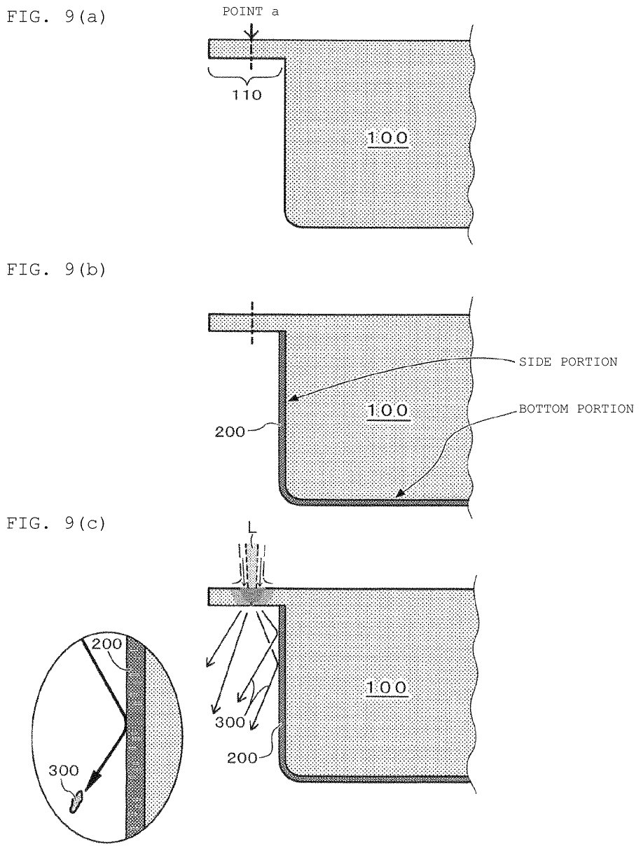

As shown in FIG. 9(a), a case is assumed where the protrusion portion 110 of the exterior body 100 of the secondary battery is cut at a point a (particularly, a case where the point a is irradiated with the laser from above). In such a case, it is preferable to form the surfactant layer on the exterior body surface located below the protrusion portion 110 because the dross highly probably adheres to such a surface. Specifically, as shown in FIG. 9(b), the surfactant layer 200 may be formed on at least a part of the outer surface of the side portion and/or the bottom portion of the exterior body 100. Although the illustrated aspect is shown in a state where the fixing stand is removed for understanding of the invention, the fixing stand may be used and in such a case, the surfactant layer is required to be formed at least on the exterior body surface exposed from the fixing stand.

When the exterior body provided with the surfactant layer in such a manner is subjected to the laser cutting, at least a part of the scattering object ejected from the laser irradiation portion is vigorously directed to the exterior body surface located below. Then, the scattering object 300 reaching the exterior body surface is repelled by the surfactant layer 200 due to the surfactant layer 200 (see FIG. 9(c)). In other words, the surfactant layer 200 acts in such a way that it exhibits a water-repellent effect on the scattering object 300 to further suitably protect the area of the exterior body under the surfactant layer from the scattering object 300. Without being bound by any specific theory, it is presumed that this is because the high-speed airflow (that is, preferably the high-speed flow caused by the assist gas) interacts with the slip effect on the surfactant layer to blow the flying dross away. Without being bound by any specific theory, it is presumed that such a slip effect is due to that the surfactant forms micelles, water molecules suitably present on the surface of the micelles cool the hot dross (the micelles are hydrophobic inside and hydrophilic on the surface, so that the water molecules easily adheres to the surface and has a high cooling effect), and therefore the scattering object hardly adheres to the surfactant layer.

In the present invention, the greater the thickness of the surfactant layer is, the higher the effect of protecting the area of the exterior body against the scattering object can be. That is, when the surfactant layer having a greater thickness is provided on the exterior body surface, the flying scattering object is further removed by the surfactant layer, and the area of the exterior body under the surfactant layer can be more suitably protected from the scattering object. Without being bound by any specific theory, it is presumed that this is because the thick surfactant layer acts so that when the dross adheres, the layer partially peels off sequentially from the surface, and can suitably continue to protect.

(Aspect of Inverted Exterior Body)

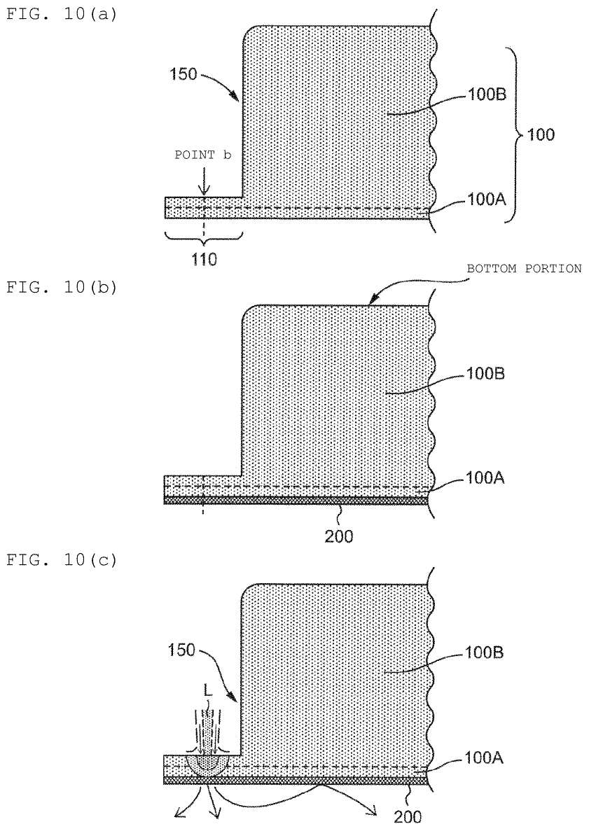

This aspect corresponds to an aspect in which the exterior body subjected to the laser processing shown in FIGS. 9(a) to 9(c) is inverted. As shown in FIGS. 10(a) to 10(c), the laser processing is performed on the exterior body 100 of the secondary battery in such a state where the protrusion portion 110 is lower than the side surface portion 150.

As shown in FIG. 10(a), a case is assumed where the protrusion portion 110 of the exterior body 100 of the secondary battery is cut at a point b. In such a case, as shown in FIGS. 10(b) and 10(c), the laser cutting is performed in such a form where the laser for the irradiation of the point b (that is, the laser L provided for the cutting) and the side surface portion 150 of the exterior body 100 of the secondary battery are adjacent to each other. As shown in FIGS. 10(a) to 10(c), the exterior body 100 of the secondary battery is placed so that the bottom portion of the exterior body 100 of the secondary battery faces upward, and the point b may be irradiated with the laser L from the upper side. This means that when the exterior body 100 of the secondary battery includes a lid portion 100A and a container portion 100B, the irradiation with the laser is performed from the side closer to the container portion 100B, in other words, the irradiation with the laser is performed from the back side of the lid portion 100A. An aspect is acceptable in which the exterior body of the secondary battery is placed so that the container portion is located on the lower side, and the irradiation with the laser is performed from the lower side (not shown).

The surfactant layer may be provided on at least one of the side surface portion or the lid portion of the exterior body of the secondary battery. In a suitable aspect, as shown in FIG. 10(b), the surfactant layer 200 is provided on the lid portion 100A of the exterior body of the secondary battery (for example, the surfactant layer 200 is not provided on the side surface portion, and may be provided only on the back side surface of the lid portion 100A). The surfactant layer can effectively reduce the influence of the scattering object during the laser processing. In particular, the surfactant layer 200 provided on the lid portion 100A can be further effective in preventing the adhering of the dross scattered with the flow of the assist gas (see FIG. 10(c)).

(Aspect of Simple Removal)

This is an aspect in which the surfactant layer is simply removed after the laser processing.

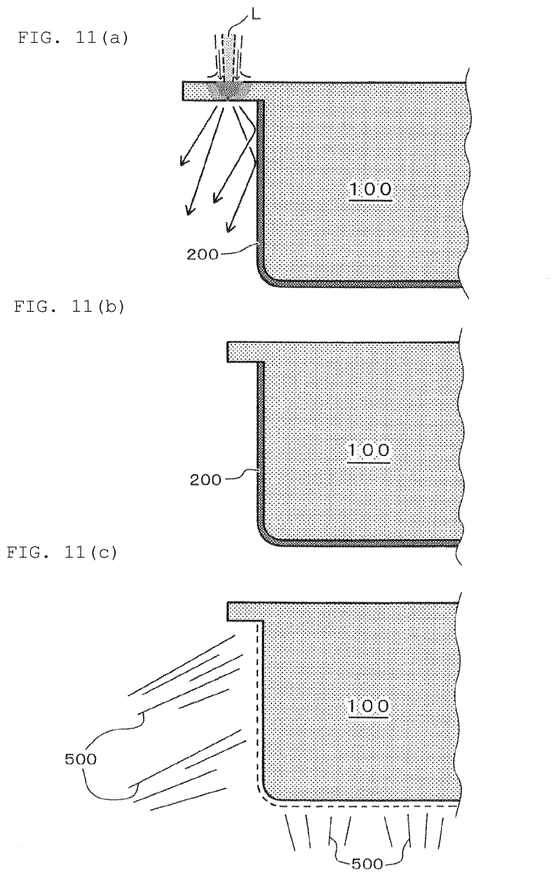

After performing the laser processing in the presence of the surfactant layer 200 (see FIG. 11(a)), at least a part of the surfactant layer 200 can remain on the exterior body surface (see FIG. 11(b)). In the present invention, the surfactant layer 200 is used only to protect the exterior body from the scattering object during the laser processing, and is not particularly necessary after the laser processing.

In the present invention, the surfactant layer can be simply washed off with water or the like. More specifically, a liquid containing at least water 500 (hereinafter, also referred to as a “removing liquid”) is provided for the exterior body after the laser processing to remove the surfactant layer 200 from the exterior body 100 (see FIG. 11(c)). For example, the removing liquid may be provided for the exterior body in a state where the liquid flows, or in a form of spray. Furthermore, the exterior body may be immersed in the liquid pool of the removing liquid.

Such a removal is particularly convenient when the surfactant layer is water-soluble. Without being bound by any specific theory, it is presumed that this is because a considerable amount of shear force acts on the surfactant layer when the removing liquid is supplied, and the surfactant layer is removed with the flow of the supplied removing liquid in a form in which the surfactant layer dissolves in or accompanies the removing liquid due to the high affinity of the surfactant layer with the removing liquid.

The removing liquid is a liquid containing at least water, and may be simply water itself or may be a mixture of water and another water-soluble liquid. As described above, in the method for manufacturing according to the present invention, the surfactant layer can be simply washed away from the exterior body using at least water after the laser processing.

An aspect of the washing away with water can be said to be particularly suitable from the viewpoint of the step of manufacturing the secondary battery. This is because the exterior body is sometimes cleaned to remove dust and dirt when finally used as a component included in the secondary battery. That is, such cleaning (particularly, conventional water cleaning) is accompanied with the removal of the surfactant layer. This means that even when the surfactant layer is provided from the viewpoint of protecting the exterior body during the laser processing according to the present invention, an additional step for the purpose of removing the surfactant layer is not particularly required, and a simple manufacturing process is provided. Furthermore, in such washing away, dirt such as oil can be removed from the exterior body by the cleaning effect of the surfactant itself, so that a further favorable result can be obtained for the final secondary battery product.

In the present invention, even if the surfactant layer remains after the above-mentioned washing away, there is no particular disadvantage. This is because the surfactant component can exert a rust prevention effect on the material of the exterior body. In other words, one of the factors of the rusting of the metal component of the exterior body is considered to be the reaction of water and oxygen with the metal, and the remaining surfactant component can form a thin protective film on the exterior body surface to prevent such a reaction.

While aspects according to the present invention have been described above, they are merely typical examples. Therefore, those skilled in the art will easily understand that the present invention is not limited to the aspects and various aspects are conceivable.

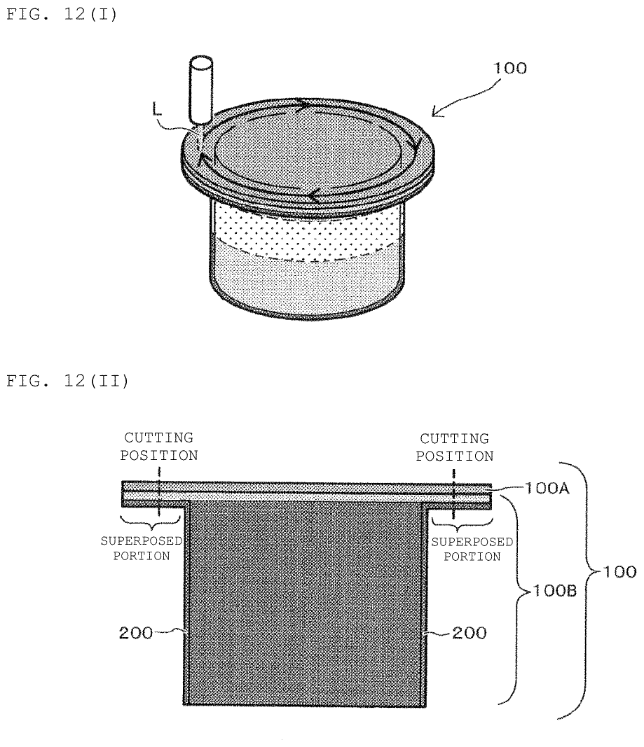

For example, in the aspect described above, the laser cutting for cutting off the protruding portion of the exterior body is exemplified, and this example means that the method for manufacturing according to the present invention can be applied to the laser cutting in an aspect as shown in FIGS. 12(I) to 12(II). That is, the method for manufacturing according to the present invention can be suitably applied to the laser cutting of the multiple part of the exterior body in a form of a hard case including the lid portion 100A and the container portion 100B (that is, superposed portion of the lid portion 100A and the container portion 100B as shown in the figure).

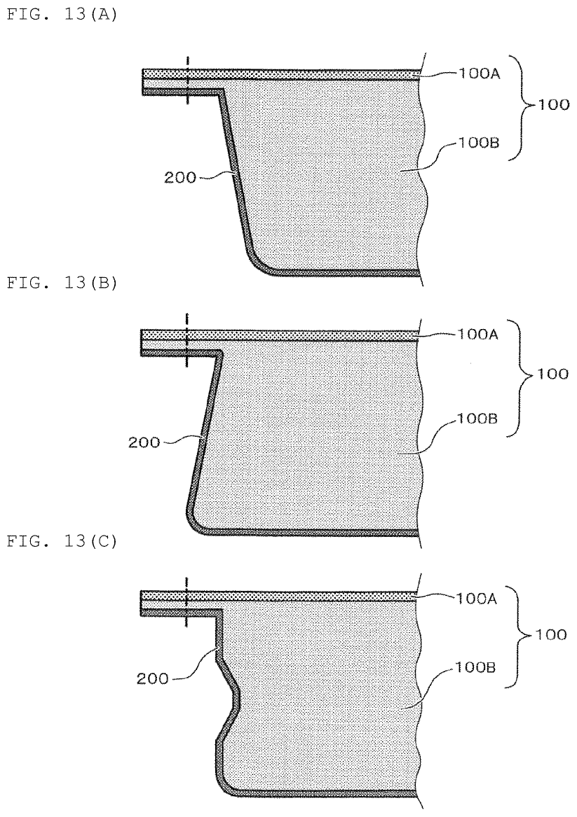

Furthermore, the method for manufacturing according to the present invention can successfully cope with any shape of the secondary battery. More specifically, since the surfactant layer for preventing the dross can be provided as desired by a simple operation such as application, the shape of the exterior body of the battery does not matter. As only an example, the present invention can be suitably implemented even when the exterior body has a shape such as the form shown in FIGS. 13(A) to 13(C) (where FIG. 13(A) shows the exterior body 100 having a tapered side surface tapering toward the lower side, FIG. 13(B) shows the exterior body 100 having a tapered side surface tapering toward the upper side, and FIG. 13(C) shows the exterior body 100 having a tapered side surface tapering toward the particular portion within the particular part).

Furthermore, in the aspect described above, the description has been given mainly of an aspect in which the dross is repelled by the surfactant layer, but the present invention is not necessarily limited to the aspect. That is, an aspect is acceptable in which the dross is retained on the surface of the surfactant layer depending on the position where the surfactant layer is provided and/or the type of the surfactant. It will be understood that even in such an aspect, the area of the exterior body under the surfactant layer can be protected from the scattering object.

### Examples

Examples related to the present invention will be described.

[Confirmation Test on Laser Processing]

The verification test described below was performed to confirm the effect of performing laser processing according to the present invention.

(Test Method)

As a specimen simulating an exterior body of a secondary battery (an exterior body of a secondary battery, having a form as shown in FIG. 12(II)), a specimen including a container portion and a lid portion and having a collar was used. The specimen was subjected to laser cutting.

Container portion: an embossed case having a depth of 4 mm and including SUS316L BA (manufactured by TOKUSHU KINZOKU EXCEL CO., LTD.) having a thickness of 100 μm

Lid portion: SUS316L ½H (manufactured by TOKUSHU KINZOKU EXCEL CO., LTD.) having a thickness of 100 μm

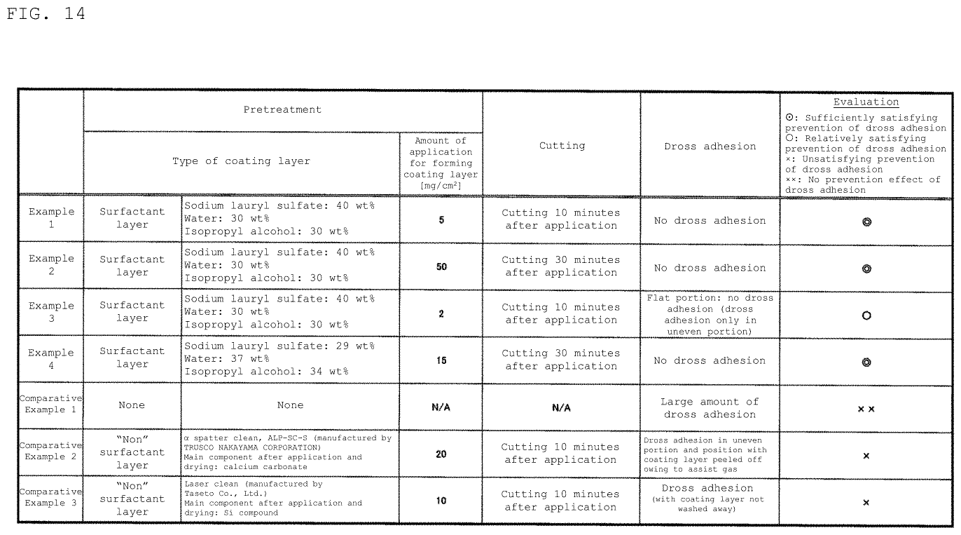

Specifically, the specimen was cut with a laser under the conditions described below so that the width of the collar was reduced from 3000 μm to 350 μm (that is, the protruding dimension of the collar was 350 μm). Prior to the cutting, pretreatments listed in the left column of the table shown in FIG. 14 were applied to the side surface of the embossed case and the back surface of the collar.

The laser irradiation was performed from the front side of the collar.

Examples 1 to 4 are cases where “there is a coating layer including a surfactant”, Comparative Example 1 is a case where “there is no coating layer”, and Comparative Examples 2 and 3 are cases where “there is a coating layer including another material other than a surfactant”.

(Conditions for Cutting)

Laser: model YLR-150/1500-QCW-AC, manufactured by IPG Photonics Corporation

Laser mode: multimode

Peak power: 250 W

Frequency: 1800 Hz

Pulse width: 100 μs

Cutting speed: 35 mm/s

Cutting width: 100 μm

Nozzle distance*¹: 0.6 mm *1: Separation distance between the nozzle and the cut part of the specimen

Nozzle inner diameter: 0.2 mm

Assist gas: nitrogen

Assist gas pressure: 0.9 MPa

(Coating Layer Components in Examples 1 to 4)

Sodium lauryl sulfate (manufactured by NACALAI TESQUE, INC.)

Pure water

Isopropyl alcohol (manufactured by KANTO CHEMICAL CO., INC.)

The results are shown in the right column of the table in FIG. 14. As can be seen from the results, it has been found that the dross adhesion can be reduced by providing the surfactant layer. In particular, it has been found that the surfactant layer acts to repel the dross during the laser cutting, so that the disadvantageous dross adhesion to the specimen hardly occurs.

The secondary battery produced by the method for manufacturing according to the present invention can be used in various fields where power storage is assumed. As only examples, the secondary battery can be used in electrical, information, and communication fields where mobile devices and the like are used (for example, fields of mobile devices such as mobile phones, smartphones, laptop computers, digital cameras, activity meters, arm computers, electronic paper, and the like), home/small industrial applications (for example, fields of electric tools, golf carts, and home/nursing/industrial robots), large industrial applications (for example, fields of forklifts, elevators, and harbor cranes), transportation system fields (for example, fields of hybrid vehicles, electric vehicles, buses, trains, electric assist bicycles, electric motorcycles, and the like), power system applications (for example, fields of various power generation, road conditioners, smart grids, general home-installed power storage systems, and the like), medical applications (medical device fields of earphone hearing aids and the like), therapeutic applications (fields of medication management systems and the like), IoT fields, space/deep-sea applications (for example, fields of space probes, submersible research vessels, and the like), and the like.

### DESCRIPTIONS OF REFERENCE SYMBOLS

1: Positive electrode
2: Negative electrode
3: Separator
5: Electrode constituent layer
10: Electrode assembly
100: Exterior body
100A: Lid portion
100B: Container portion
100′: Cut exterior body edge
110: Protruding portion of exterior body
140: Laser irradiation portion
150: Side surface of exterior body
150′: Exposed side surface portion of exterior body
160: Bottom surface of exterior body
170: Lower surface of protruding portion of exterior body
170′: Exposed lower surface portion of exterior body
200: Surfactant layer
250: Assist gas
300: Scattering object (for example, dross)
400: Fixing stand
410: Base of fixing stand
420: Side wall of fixing stand
500: Liquid containing at least water (removing liquid)
L: Laser

1. A method for manufacturing a secondary battery having an electrode assembly and an exterior body housing the electrode assembly, the method comprising:
placing a surfactant layer on at least a part of the exterior body of the secondary battery; and
laser processing the exterior body.

2. The method according to claim 1, wherein the surfactant layer is configured to protect the exterior body from a scattering object generated by the laser processing.

3. The method according to claim 1, wherein the at least the part of the exterior body having the surfactant layer is an area of the exterior body that is not subjected to the laser processing.

4. The method according to claim 1, wherein the laser processing is initially conducted on an area of the exterior body that does not have the surfactant layer and continues to an area of the exterior body having the surfactant layer.

5. The method according to claim 1, wherein the laser processing is a laser cutting.

6. The method according to claim 5, wherein the laser cutting cuts off an edge portion of the exterior body.

7. The method according to claim 5, further comprising using an assist gas in combination with the laser cutting.

8. The method according to claim 1, wherein the surfactant layer is placed on an exterior body surface located on a side of the exterior body opposite to a side subjected to the laser processing.

9. The method according to claim 1, wherein the surfactant layer is a water-soluble surfactant layer.

10. The method according to claim 1, further comprising washing away the surfactant layer from the exterior body after the laser processing.

11. The method according to claim 10, wherein the surfactant layer is washed away from the exterior body using at least water after the laser processing.

12. The method according to claim 10, further comprising cleaning the exterior body after the washing away of the surfactant layer.

13. The method according to claim 1, wherein the surfactant layer is placed on the at least a part of the exterior body by providing a raw material layer containing a surfactant and a solvent on a surface of the exterior body.

14. The method according to claim 13, further comprising performing a drying treatment after the raw material layer is provided on the surface of the exterior body to promote the evaporation and removal of the solvent from the raw material layer.

15. The method according to claim 14, wherein the drying treatment is carried out by putting the surfactant layer under reduced pressure or a vacuum and/or subjecting the surfactant layer to a heat treatment under atmospheric pressure.

16. The method according to claim 2, wherein the scattering object is dross.

17. The method according to claim 1, wherein the electrode assembly includes a positive electrode and a negative electrode that each have a layer capable of absorbing and releasing a lithium ion.

18. The method according to claim 1, wherein a thickness of the surfactant layer is 0.1 μm to 200 μm.
